(19) United States
(12) Patent Application Publication
(10) Pub. No.: US 2014/0365914 A1
(43) Pub. Date: Dec. 11, 2014

(54) DETERMINING MESSAGE DATA TO PRESENT

(71) Applicant: Alibaba Group Holding Limited, George Town (KY)

(72) Inventor: Meng Peng, Hangzhou (CN)

(21) Appl. No.: 14/296,915

(22) Filed: Jun. 5, 2014

(30) Foreign Application Priority Data
Jun. 9, 2013 (CN) 201310231094.9

(51) Int. Cl. H04L 12/58; G06F 17/28; G06F 17/30; H04L 29/08

(52) U.S. Cl. CPC H04L 51/046; H04L 67/02; G06F 17/28; G06F 17/30905
USPC 715/752

(57) ABSTRACT

Determining message data to present based on a message is disclosed, including: identifying a web address included in a message sent from a first instant messaging client to a second instant messaging client; extracting identifying information to use to identify page content from the web address; retrieving message data corresponding to the identifying information including by sending a processing request to a server; and presenting the message data within a display window of the second instant messaging client.

### CROSS REFERENCE TO OTHER APPLICATIONS

This application claims priority to People's Republic of China Patent Application No. 201310231094.9 entitled A METHOD AND EQUIPMENT FOR DISPLAYING INFORMATION ON INSTANT MESSAGING CLIENTS AND AN INFORMATION DISPLAY SYSTEM, filed Jun. 9, 2013 which is incorporated herein by reference for all purposes.

### FIELD OF THE INVENTION

This application involves the field of network communication technology. In particular, the application involves techniques for determining additional information in an instant messaging system.

### BACKGROUND OF THE INVENTION

Conventionally, the sending of various types of messages using instant messaging clients is common. Some instant messages may include links such as Uniform Resource Locators (URLs). When a URL that is included in a received instant message is displayed for the recipient user, the user is unable to know the content information included in the page corresponding to the URL without selecting the URL to open the page associated with the URL. In such situations, the user may desire to view the contents associated with the URL but also be concerned that the URL could be associated with a network virus.

### BRIEF DESCRIPTION OF THE DRAWINGS

Various embodiments of the invention are disclosed in the following detailed description and the accompanying drawings.

FIG. 1 is a diagram showing an embodiment of a system for determining message data to present based on a message.

FIG. 2 is a flow diagram showing an embodiment of a process for determining message data to present based on a message.

FIG. 3 is a flow diagram showing an embodiment of a process for identifying a web address included in a message.

FIG. 4 is a flow diagram showing an embodiment of a process for retrieving message data corresponding to identifying information usable to identify page content.

FIG. 5 is a sequence diagram showing an example of a process of determining message data to present based on a message.

FIG. 6 shows an example display window of the instant messaging client presenting the URL and the message data together (along with other content of the message).

FIG. 7 shows an example of an image browser presenting multiple images of a set of retrieved message data.

FIG. 8 is a diagram showing an embodiment of a client device.

FIG. 9 is a diagram showing an embodiment of a system for determining message data to present based on a message.

FIG. 10 is a functional diagram illustrating an embodiment of a programmed computer system for implementing a service for determining message data to present based on a message.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of determining message data to present are described here. A message is received at an instant messaging client from another instant messaging client. A web address that is included in the message is identified. For example, the web address is a uniform resource locator (URL). At least a portion of the web address associated with identifying information usable to identify page content is extracted from the web address. Message data corresponding to the identifying information usable to identify page content is retrieved from a server. Message data includes text and/or image(s) that are associated with the content associated with the web page corresponding to the identified web address. The message data is presented within a display window of the instant messaging client. In various embodiments, the message data is presented within the display window of the instant messaging client together with the contents of the received message, including the web address.

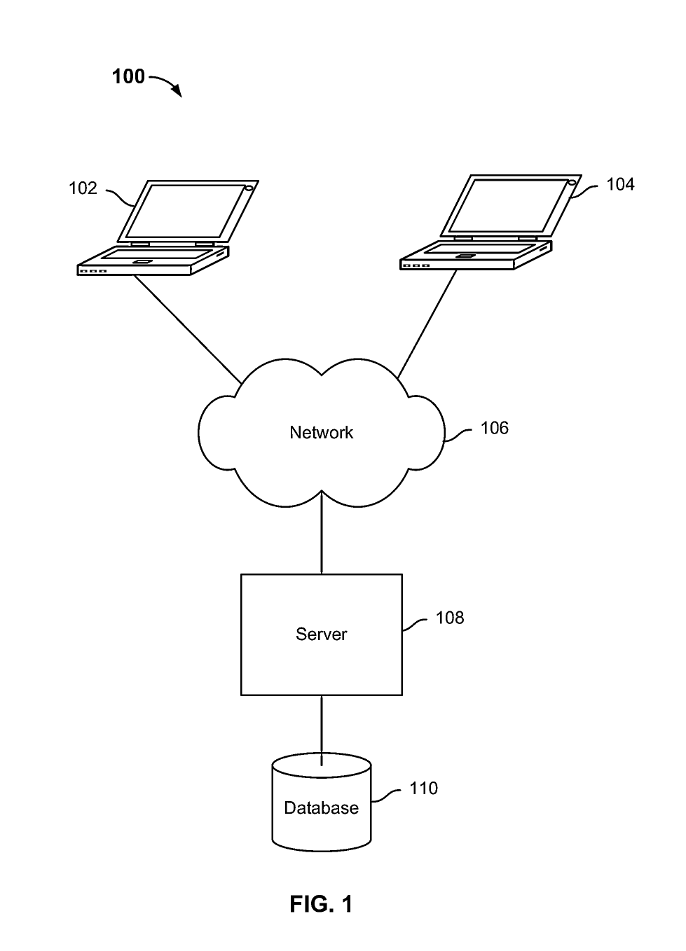

FIG. 1 is a diagram showing an embodiment of a system for determining message data to present based on a message. In the example, system 100 includes client device 102, client device 104, network 106, server 108, and database 110. Network 106 includes high-speed data networks and/or telecommunications networks.

While client device 102 and client device 104 are shown to be laptop computers in the example, other examples of client device 102 and client device 104 can be desktop computers, smart phones, mobile devices, tablet devices, and/or any other computing device.

An instant messaging client (e.g., software application) is executing at each of client device 102 and client device 104. User A using client device 104 can input a message into the instant messaging client executing at client device 104 to send to User B using client device 102. The message may comprise a short message service (SMS) message, a text message, and/or any other type of instant message, and include a web address (e.g., a URL). The instant messaging client executing at client device 102 is configured to receive the message from client device 104 and determine message data to present with the contents of the message at a display window of that instant messaging client. The instant messaging client executing at client device 102 identifies the web address (e.g., URL) from the message. Then, identifying information usable to identify page content is extracted from the identified web address. The instant messaging client executing at client device 102 sends a processing request including the identifying information to server 108.

Server 108 receives the processing request from client device 102 and retrieves message data corresponding to the identifying information based on sets of message data and mappings between identifying information and corresponding message data stored at database 110. In some embodiments, server 108 acquires the message data corresponding to the processing request by using a predetermined application programming interface (API) that is configured to retrieve corresponding message data for a given set of identifying information extracted from a web address. In some embodiments, server 108 is configured to support an e-commerce website and the API is configured to retrieve message data associated with the e-commerce website. Sets of message data stored at database 110 can be configured (e.g., by a system administrator) to include content (e.g., text and/or images) that are from and/or relevant to the page that the web address references. For example, database 110 can be implemented with a MySQL database). A set of message data may include several fields and the fields can be stored based on their respective priorities. In some embodiments, database 110 may include or otherwise be attached to a separate cache that stores recently requested sets of message data. For example, a requested set of message data retrieved from database 110 can be stored in the cache to more quickly satisfy subsequent requests for the same data (rather than retrieving the data from the database again). Mappings between identifying information and corresponding message data stored at database 110 can also be configured (e.g., by a system administrator). Server 108 returns the retrieved message data to client device 102.

The instant messaging client executing at client device 102 receives the message data and presents it at a display window. In various embodiments, the message data is presented simultaneously/together with the web address and/or other content of the message at the display window of the instant messaging client at client device 102, as will be described in further detail below.

On existing instant messaging platforms, a user who receives a message with a web address usually sees only the web address in the display of the message. However, various embodiments described herein enable the user to simultaneously see a display of the web address as well as a display of additional message data (e.g., content from the web page associated with the web address), which was not included in the received message, without accessing the web address.

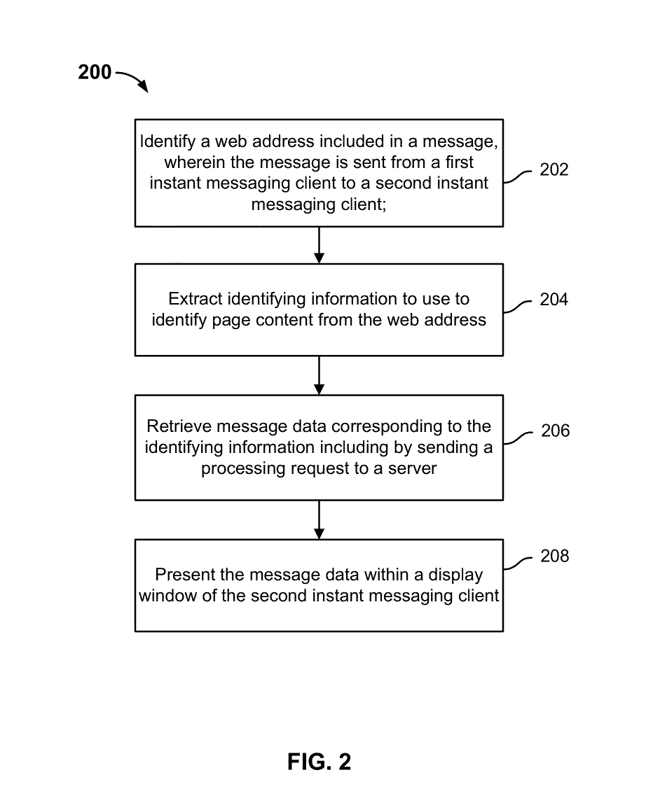

FIG. 2 is a flow diagram showing an embodiment of a process for determining message data to present based on a message. In some embodiments, process 200 is implemented at system 100 of FIG. 1. Specifically, in some embodiments, process 200 is performed by client device 102 of system 100 of FIG. 1.

At 202, a web address included in a message sent from a first instant messaging client to a second instant messaging client is identified.

Various types of messages can be received at an instant messaging client application executing at a client device for a user of the client device. For example, the instant message may comprise a short message service (SMS) message, a text message, or any other type of message that can be sent and received between different instant messaging client applications executing on client devices. A message can be composed by a sender user and sent to the instant messaging client executing at the client device of the recipient user via an instant messaging client executing at the client device of the sender user. Each message may include text, images, and/or web addresses, for example. In some embodiments, a web address comprises a URL. A URL comprises a character string that is used to indicate the address information of a resource (e.g., a web page).

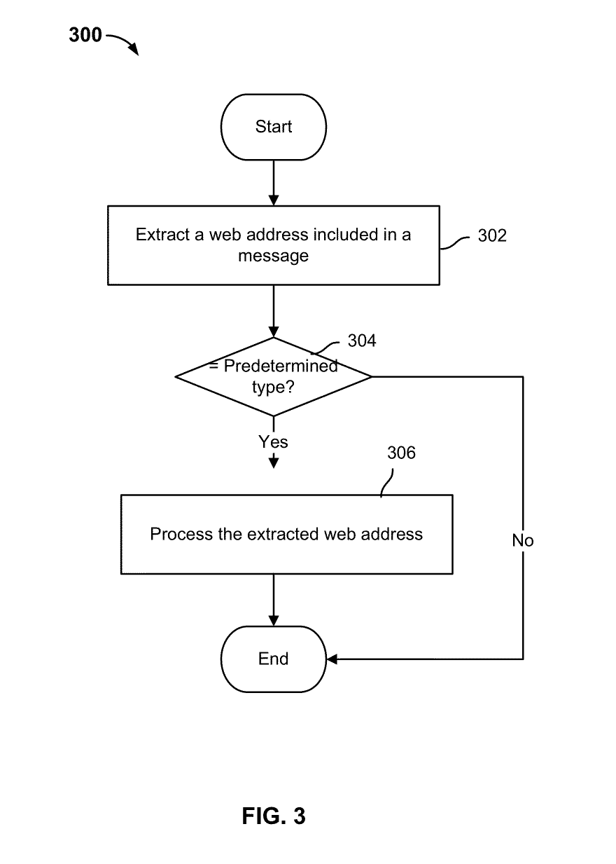

A message that is received at an instant messaging client application is checked for the presence of a web address (e.g., a URL is found by parsing the message and detecting the string “http” or “https”). In some embodiments, a URL that is found in the message is also checked for whether the URL is associated with a predetermined type. FIG. 3, below, describes an example of identifying a web address in a received message.

Returning to process 200 of FIG. 2, for messages that include text information and/or image information, the recipient user is able immediately to understand the intentions of the sender of the information. However, when a message contains a URL, the recipient user may not immediately know what kind of content is associated with the web page associated with the URL. Conventionally, the content of this page associated with the URL can only be obtained when the user accesses/opens the page corresponding to this URL (e.g., by selecting the URL via a user interface of the client device).

In various embodiments, certain processing can be performed with respect to each of the one or more web addresses (e.g., URLs) contained in instant messages so that the user is able quickly to consume the content associated with the page corresponding to this web address without needing to make a selection to access/open the page corresponding to the web address (e.g., by making a user selection at the user interface to access the URL). In some embodiments, when the current message is identified to include a web address, it is further checked whether the web address is of a predetermined type (as described with the example of FIG. 3, below). If the web address is of the predetermined type, then the web address is considered to be recognizable by the recipient instant messaging client and further processing (as described with steps 204, 206, and 208) is applied to the web address. For example, if the web address is not of the predetermined type, then the web address is considered to be unrecognizable by the recipient instant messaging client and further processing (as described with steps 204, 206, and 208) is not applied to the web address.

At 204, identifying information to use to identify page content is extracted from the web address.

When the message contains a web address, identifying information can be extracted from this web address based on one or more preset rules. In some embodiments, identifying information includes one or more parameters that can be used to identify page content and their corresponding parameter values. Examples of identifying information usable to identify page content comprise keywords and/or values associated with specified objects. For example, a specified object is configured by a system administrator. Examples of specified objects comprise product identifiers, type identifiers, and/or user identifiers that can be used to identify relevant product information and/or user information. For example, the extracted identifying information may include an extracted product_id parameter and the corresponding parameter value. In various embodiments, the identifying information usable to identify page content can be extracted from a web address of the message according to one or more preset character string matching rules that describe the formats of different types of parameters and parameter values. For example, the preset character string matching rules are configured by a system administrator.

At 206, message data corresponding to the identifying information is retrieved including by sending a processing request to a server.

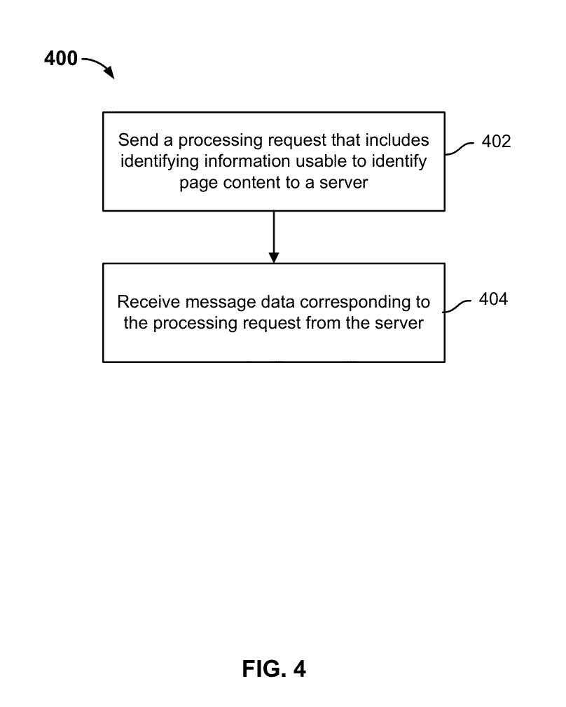

In some embodiments, the determined identifying information usable to identify page content is sent in a processing request to a server that stores and/or has access to stored message data and mappings between message data and identifying information. For example, the server comprises a server associated with the instant messaging service that is associated with the instant messaging client. In various embodiments, “message data” refers to at least some of the primary content that is included in a page corresponding to a URL from which the identifying information usable to identify page content was extracted. In various embodiments, primary content includes one or more of the following: text, image(s), audio, and/or video. The primary content corresponding to the identifying information usable to identify page content may include content associated with the page corresponding to the URL from which the identifying information usable to identify page content was extracted and/or the content associated with other pages (e.g., the primary content may include the time, location, subject and other information extracted from other relevant web pages). FIG. 4, below, describes an example of retrieving message data corresponding to the identifying information usable to identify page content.

The message data can be retrieved in various data formats such as XML, JSON, and/or HTML, for example. The following is an example set of message data in JSON format retrieved for an identifying information of a product ID:

```
      {
        “evaluateNumber”: 0,
        “msg”: “Success!”,
        “name”: “ [ Lynx ] Haier intelligent life presale Leader /
        commander LE39MXF6/LED
LCD TV networks”,
        “otherNeeds”:“”,
        “picUrl”:
“http://img03.taobaocdn.com:80/tfscom/i3/18984029273779744/
T1XqSJFadaXXXXXXXX_!!0--item_pic.jpg”,
        “postFeeAsString”: “0.00”,
        “priceAsString”: “3099.00”,
        “pricingAsString”: “0.00”,
        “salesCount”: 151,
        “status”: 0
}
```

The following are descriptions of each parameter included in the example JSON message data above:

```
        {
          “evaluateNumber”: the number of times that the product has
          been reviewed
          “msg”: status indicator (status of the processing request)
          “name”: the name of the product
          “otherNeeds”: favorable conditions associated with the product
          “picUrl”: the product's main picture URL (the full link and the
size of the picture, which can be determined according to the needs of
each client, e.g., picUrl + width × height.jpg)
          “postFeeAsString”: commodity shipping ( Unit: RMB )
          “priceAsString”: goods Original ( Unit: RMB )
          “pricingAsString”: commodity price ( Unit: RMB )
          “salesCount”: total sales of the product within the past 30 days
          “status”: status indicator (e.g., 0: normal , 5: query does not
          exist )
}
```

For example, if the URL references/points to the information page associated with a particular product and the extracted identifying information were a product_id parameter and product_id parameter value, the retrieved message data can include text information such as the product name, price, discount, customer rating, delivery area, explanation of shipping costs, and also the product's one or more images.

Returning to FIG. 2, at 208, the message data is presented within a display window of the second instant messaging client. In some embodiments, the retrieved message data (e.g., text and/or images) is presented within a display window of the instant messaging client. For example, the display window may comprise the dialog window in which messages exchanged between the recipient user and one other user are displayed. In various embodiments, the retrieved message data is presented together with the web address and other content that are included the received message. For example, the retrieved primary content information can be displayed below the web address included in the message and/or below all other content (including the web address) that is included in the message.

Therefore, information that is not included in the message (the message data) but that corresponds to a web address that is included in the message can automatically be retrieved and displayed in the instant messaging client with the contents included in the message according to embodiments described herein. As such, the recipient user can view the contents of the received message including the web address (e.g., URL) simultaneously with the retrieved message data corresponding to the web address in the display window of the instant messaging client without needing to make a selection to access the page associated with the web address.

In some embodiments, if the message data includes one or more images, an image browser may be invoked (e.g., by the instant messaging client) to display at least some of the one or more images. For example, if the message data includes multiple images, then one such image may be displayed in the display window of the instant messaging client and in response to a user selection of the displayed image, the image browser can be invoked to display all the images included in the message data. In various embodiments, the image browser is a feature of the instant messaging client or a separate software application (e.g., a web browser application) executing on the same client device. A display window of the image browser may be able to display the image(s) of the message data in a larger and/or more conspicuous manner than the display window of the instant messaging client. Additionally, if the message data includes multiple images, in order to save space in the display window of the instant messaging client, only one image is displayed in the display window of the instant messaging client, while all the images are displayed by invoking the image browser.

FIG. 3 is a flow diagram showing an embodiment of a process for identifying a web address included in a message. In some embodiments, process 300 is implemented at system 100 of FIG. 1. Specifically, in some embodiments, process 300 is implemented at client device 102 of system 100 of FIG. 1. In some embodiments, step 202 of process 200 of FIG. 2 can be implemented using process 300.

Process 300 can be applied for each web address that is included in a received message.

At 302, a web address included in a message is extracted. In various embodiments, every time the instant messaging client receives a message, the instant messaging client uses a regular expression to determine whether or not this received message includes a web address (e.g., a URL). In various embodiments, a regular expression refers to a single character string, certain pre-defined patterns of characters, and/or combinations of specific characters that describe and/or match a series of character strings that describe and/or conform to a certain syntactical rule. Put another way, a regular expression is a logical formula that comprises a “rule character string.” This “rule character string” is used to express a kind of filter logic for character strings. Therefore, a first regular expression that matches the syntactical patterns of a web address is configured and compared against the text in the message to determine a matching portion to extract as a web address. For example, the first regular expression can be configured to match a portion of the text of a message that comprises the format of a common URL (e.g., “http://www.website.com”).

At 304, it is determined whether the extracted web address is of a predetermined type. In the event that the extracted web address is associated with the predetermined type, control is transferred to 306. If the web address is determined to be of the predetermined type, then it is determined to be in a format that can be recognized by the instant messaging client for the further processing as described herein (e.g., step 204 of process 200 of FIG. 2). Otherwise, in the event that the extracted web address is not associated with the predetermined type, process 300 ends and no web address is determined to be identified for further processing. If the web address is determined not to be of the predetermined type, then it is determined to not be in a format that can be recognized by the instant messaging client for the further processing as described herein (e.g., step 204 of process 200 of FIG. 2).

In various embodiments, a web address (e.g., URL) of a predetermined type comprises a web address that is associated with one or more specified objects. For example, a URL of a predetermined type references, identifies, and/or points to a resource (e.g., web page) associated with one or more specified objects. Examples of specified objects are products or activities. The specified objects can be configured by a system administrator. In some embodiments, a second regular expression that matches the syntactical patterns of a web address of a predetermined type is configured and compared against the extracted web address to determine whether at least a portion of the extracted web address matches the second regular expression and is therefore of a predetermined type. For example, the second regular expression can be configured to match a portion of a web address that references, identifies, and/or points to a product identifier.

At 306, the extracted web address is processed. In some embodiments, because the extracted web address is a predetermined type, then it is determined to be in a format that can be recognized by the instant messaging client for the further processing as described herein (e.g., step 204 of process 200 of FIG. 2).

FIG. 4 is a flow diagram showing an embodiment of a process for retrieving message data corresponding to identifying information usable to identify page content. In some embodiments, process 400 is implemented at system 100 of FIG. 1. Specifically, in some embodiments, process 400 is implemented at client device 102 of system 100 of FIG. 1. In some embodiments, step 206 of process 200 of FIG. 2 can be implemented using process 400.

Process 400 can be applied for each web address that is included in a received message.

At 402, a processing request that includes identifying information usable to identify page content is sent to a server. In some embodiments, the instant messaging client includes the identifying information usable to identify page content extracted from a message (e.g., at step 204 of process 200 of FIG. 2) in a request to retrieve the message data associated with this identifying information to the server. In some embodiments, the server is configured to store or access a storage (e.g., database) that stores message data and corresponding identifying information usable to identify page content. In some embodiments, message data that corresponds to a particular set of identifying information usable to identify page content is configured to include primary content extracted from the page referenced by the URL from which the identifying information usable to identify page content was extracted and/or from other pages that are not referenced by the URL from which the identifying information usable to identify page content was extracted. These other pages from which primary content is included in the message data may comprise web pages that are relevant to the identifying information extracted from the web address of the message.

At 404, message data corresponding to the processing request is received from the server. When the server receives the processing request from the instant messaging client, the server, based on the identifying information usable to identify page content, retrieves the message data corresponding to this identifying information using a configured Application Programming Interface (API). For example, at least a portion of the identifying information of the processing request can be used as a parameter in an API call to retrieve the corresponding message data. The retrieved message data is then returned to the instant messaging client.

In some embodiments, the processing request comprises an HTTP request. In some embodiments, the server is associated with an e-commerce website and the API is provided by the e-commerce website. For example, if the identifying information extracted from the web address includes product_id parameter and corresponding parameter value of “product_id=38973906347,” then an example processing request can be the following: http://web.wangwang.taobao.com/tbskip/commodityInfo.htm?nid=38973906347&realm=item. The message data can be retrieved in various data formats such as XML, JSON, and/or HTML, for example.

In some embodiments, the type of content to include or exclude from a set of retrieved message data is configurable. For example, the processing request sent by the instant messaging client may specify a subset of all possible fields in the requested set of message data to be returned from the server. For example, if all the possible fields in a set of message data associated with a product includes the price of the product, an image of the product, user reviews of the product, the dimensions of the product, the weight of the product, and the origin of the product, the processing request may request to only retrieve the price of the product and an image of the product instead of all the available message data. In another example, the API is configured to permit only a subset of all possible fields in the requested set of message data to be returned from the server.

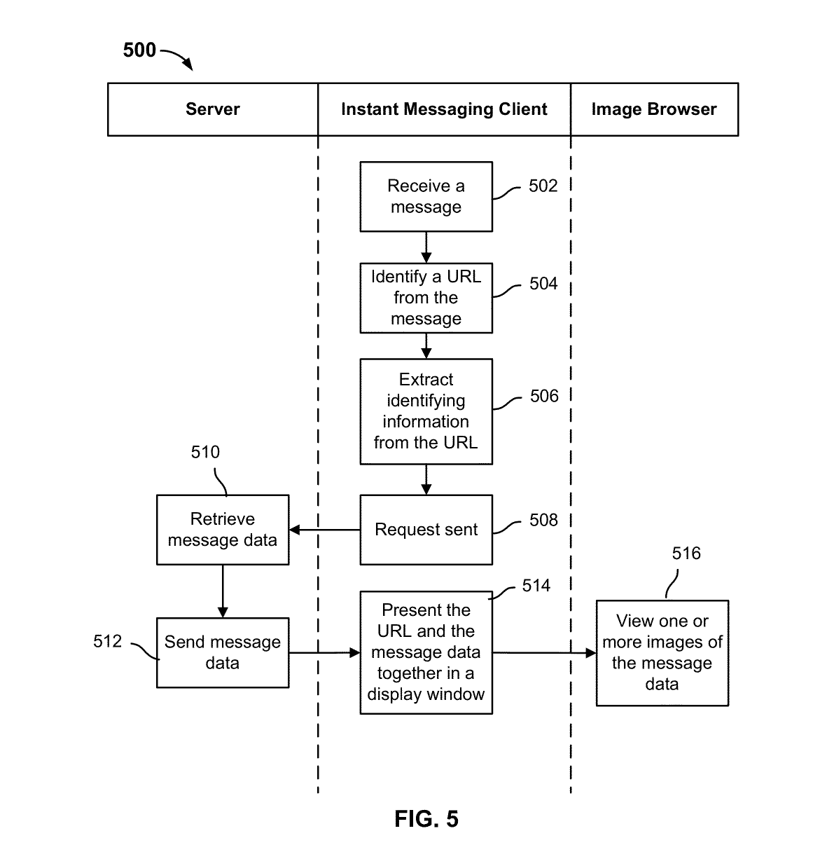

FIG. 5 is a sequence diagram showing an example of a process of determining message data to present based on a message. In some embodiments, process 500 is implemented at system 100 of FIG. 1. In some embodiments, the server of process 500 can be implemented by server 108 of system 100 of FIG. 1. In some embodiments, the instant messaging client of process 500 can be implemented at client device 102 of system 100 of FIG. 1. In some embodiments, the image browser of process 500 can be implemented at client device 102 of system 100 of FIG. 1.

At 502, a message is received at the instant messaging client. For example, the message received by the instant messaging client includes text and a URL such as the following: “Hi, I have something good to share with you, http://product.dangdang.com/product.aspx?product_id=60336243#ddclick?act=click&pos=6033 6243_{—}0_{—}1_m&cat=4006498&key=&qinfo=&pinfo=&minfo=113_{—}1_{—}48&ninfo=&custid=&permi d=20120813111516781911563449475562905&ref=&rcount=&type=&t=1369280925000.”

At 504, a URL from the message is identified. For example, the URL is identified in a manner similar to step 202 of process 200 of FIG. 2 or to process 300 of FIG. 3. For example, the instant messaging client compares the message against a configured regular expression and extracts the portion of the message that matches the regular expression as the URL. Returning to the example above, the identified URL of the message is:

“http://product.dangdang.com/product.aspx?product id=60336243#ddclick?act=c lick&pos=60336243_{—}0_{—}1_m&cat=4006498&key=&qinfo=&pinfo=&minfo=113_{—}1_{—}48&ninfo=&custid=&permid=20120813111516781911563449475562905&ref=&rcount=&type=&t=13692 80925000.”

At 506, identifying information usable to identify page content is extracted from the URL. For example, identifying information usable to identify page content is extracted in a manner similar to step 204 of process 200 of FIG. 2. For example, it is determined whether or not the extracted URL is a URL of a predetermined type using, for example, step 304 of process 300 of FIG. 3. The URL in the example above is determined to be associated with the specified object of a product and is therefore of a predetermined type. For example, the product id parameter and the corresponding parameter value can be extracted from the URL in the example above. The identifying information usable to identify page content that can be extracted from the URL in the example above is the following product id parameter and the corresponding parameter value: “product_id=60336243”.

At 508, a request that includes the identifying information usable to identify page content is sent to the server. The instant messaging client sends a request to the server to retrieve the message data corresponding to the identifying information.

At 510, the server receives the request for the message data from the instant messaging client and uses the request to retrieve corresponding message data. For example, the request can be processed in a manner similar to step 404 of process 400 of FIG. 4. The relevant message data corresponding to the identifying information usable to identify page content included in the request is retrieved using a configured API. For example, if the URL references/points to the information page associated with a particular product, the retrieved message data can include text information such as the product name, price, discount, customer rating, delivery area, explanation of shipping costs, and also the product's one or more images. In some embodiments, the type of content to include or exclude from a set of retrieved message data is configurable. For example, the processing request sent by the instant messaging client can specify a subset of all possible fields in the requested set of message data to be returned from the server. In another example, the API is configured to permit only a subset of all possible fields in the requested set of message data to be returned from the server. Returning to the extracted identifying information for the URL in example above, message data including, for example, the product name, price, discount, customer rating, delivery area, explanation of shipping costs, and also the product's one or more images corresponding to product_id=60336243 can be retrieved by the server using the API.

At 512, the message data is sent from the server to the instant messaging client. The server returns this message data comprising text and/or image data to the instant messaging client. The message data can be returned in JSON format, XML format, and/or HTML format.

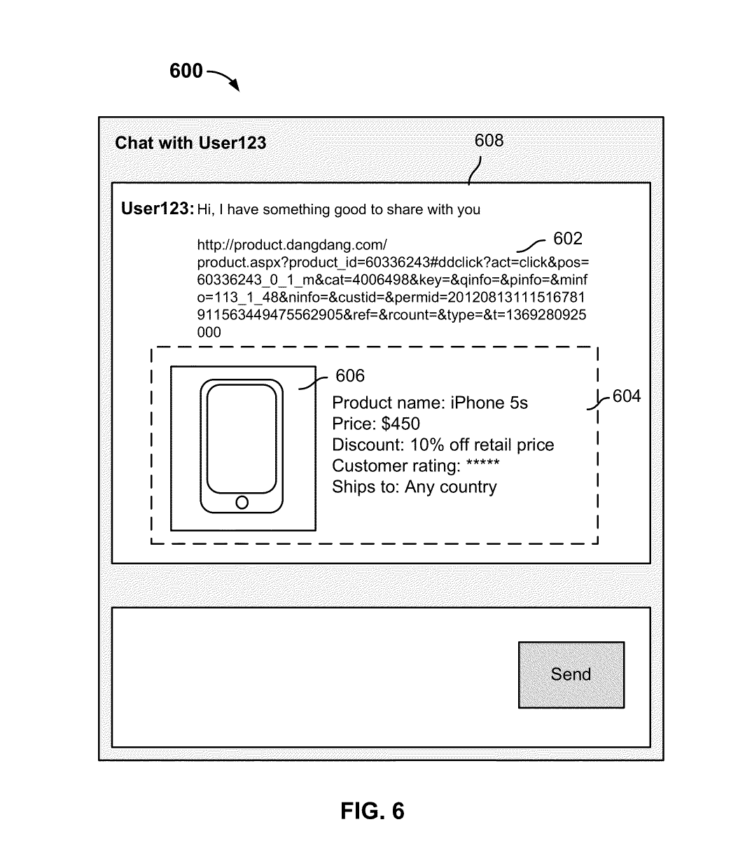

At 514, the URL and the message data are presented together in a display window of the instant messaging client. For example, the display window comprises a dialog window that displays messages received from one or more users and/or sent by the user using the instant messaging client. FIG. 6 shows an example display window of the instant messaging client presenting the URL and the message data together (along with other content of the message). In the example of FIG. 6, user interface 600 is associated with an instant messaging client. The instant messaging client includes display window 608 that displays the messages sent to and received from user “User123.” The message sent by User123 shown in display window 608 includes URL 602. After the message is processed using steps 202 through 206 of process 200 of FIG. 2, message data corresponding to the extracted identifying information of “product_id=60336243” is received and presented with the URL of the message and other content of the message. Display window 608 includes a presentation of URL 602 as well as a presentation of the retrieved message data in area 604 below the presentation of URL 602. Area 604 includes message data such as image of the product 606 corresponding to “product_id=60336243” and other text-based information such as “Product name: iPhone 5s, Price $450, Discount: 10% off retail price, Customer rating: *****, Ships to: Any country” corresponding to “product_id=60336243.”

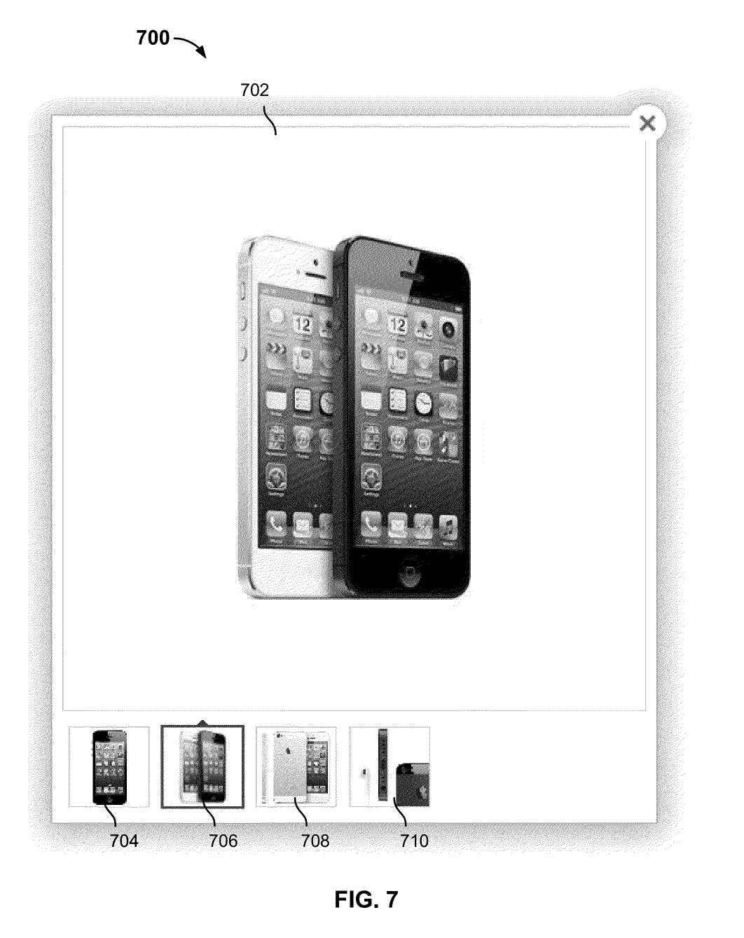

Returning to FIG. 5, in some embodiments, if the retrieved message data includes multiple images, the image browser (e.g., which can be a component of the instant messaging client or a separate application) can be invoked to present the images. At 516, the image(s) of the message data are sent to be viewed at the image browser. For example, in response to a user's selection of image of the product 606 in display window 608 of FIG. 6, the image browser can be invoked to display image of product 606 and/or any additional images of the product included in the message data. FIG. 7 shows an example of an image browser presenting multiple images of a set of retrieved message data. For example, the image browser may be invoked in response to a user selection of an image included within presented message data in a display window of an instant messaging client. In some embodiments, the user interface of an invoked image browser may be presented in an overlay to other content (e.g., the display window of the instant messaging client) on the screen. User interface 700 of the image browser includes a display area 702 and thumbnails 704, 706, 708, and 710. Each thumbnail image is a thumbnail-sized version of an image included within a set of retrieved message data corresponding to a URL. To view a larger version of a thumbnail image in display area 702, the user can select the thumbnail. Thus, the image browser enables a preview of multiple images related to a URL included in a message without requiring for the user to select to access the URL.

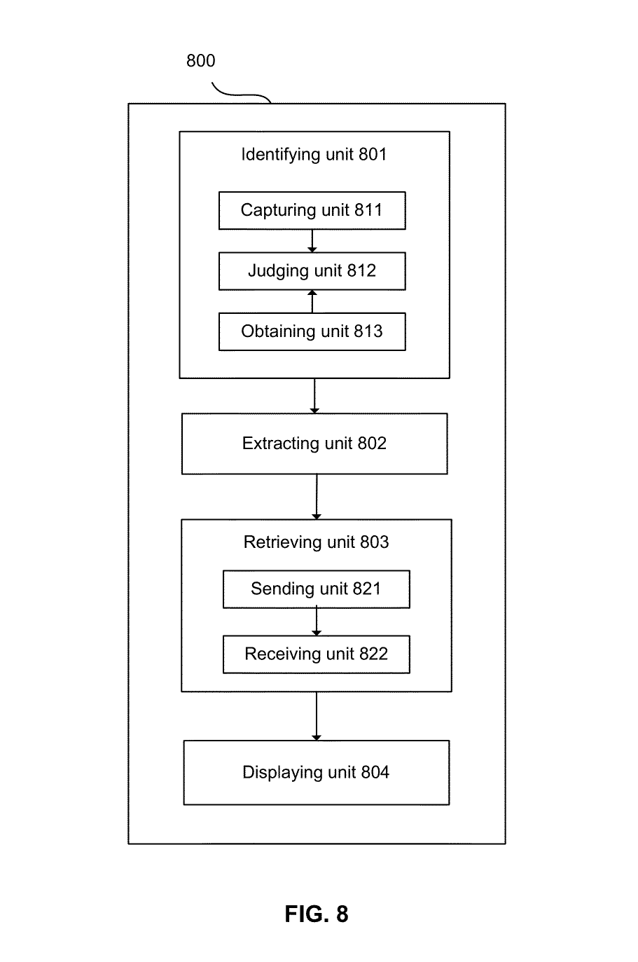

FIG. 8 is a diagram showing an embodiment of a client device. In the example, client device 800 includes identifying unit 801, extracting unit 802, retrieving unit 803, and displaying unit 804.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Identifying unit 801 is configured to identify web addresses included in messages received at client device 800. In some embodiments, identifying unit 801 further includes capturing unit 811, judging unit 812, and obtaining unit 813. Capturing unit 811 is configured to extract a web address that is included in a received message. Judging unit 812 is configured to determine whether the extracted web address is of a predetermined type. Obtaining unit 813 is configured to extract the identifying information from the web address.

Extracting unit 802 is configured to extract the identifying information from the web address.

Retrieving unit 803 is configured to retrieve the message data corresponding to the extracted identifying information. For example, the message data comprises at least one of the following: text information and image information. In some embodiments, retrieving unit 803 further includes sending unit 821 and receiving unit 822. Sending unit 821 is configured to send the extracted identifying information in a processing request to the server. Receiving unit 822 is configured to receive the message data corresponding to the processing request from the server.

Displaying unit 804 is configured to display the message data in a display window of the instant messaging client. In some embodiments, when the message data contains image information, displaying unit 804 may further comprise an image browser (not shown) that is invoked to display the image information of the message data.

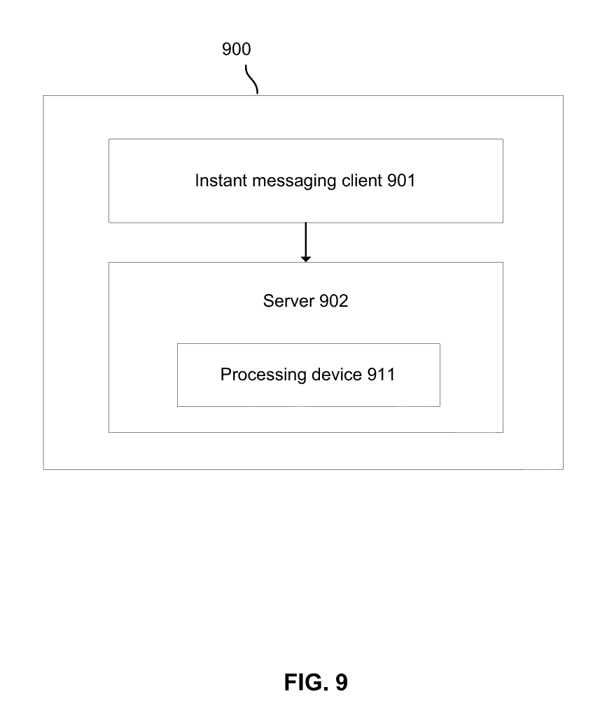

FIG. 9 is a diagram showing an embodiment of a system for determining message data to present based on a message. System 900 includes instant messaging client 901 and server 902.

In some embodiments, instant messaging client 901 can be implemented using client device 800 of FIG. 8.

Server 902 is configured to receive a processing request from instant messaging client 901, where the processing request includes identifying information. Server 902 is configured to retrieve the message data corresponding to the identifying information and return the message data to instant messaging client 901. In some embodiments, server 902 is configured to retrieve the message data using a configured API. In some embodiments, server 902 further includes processing device 911. Processing device 911 is configured to retrieve message data corresponding to the identifying information included in the processing request. For example, processing device 911 obtains the message data through the API using the identifying information.

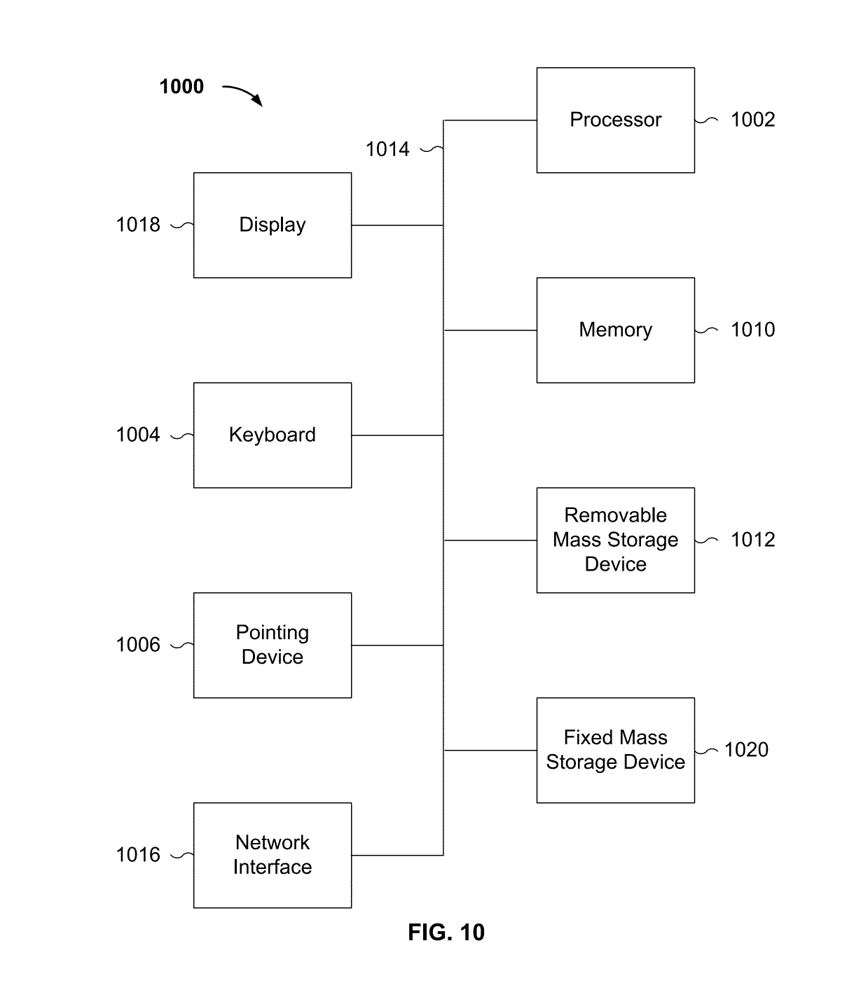

FIG. 10 is a functional diagram illustrating an embodiment of a programmed computer system for implementing a service for determining message data to present based on a message. As will be apparent, other computer system architectures and configurations can be used to determine message data to present based on a message. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018). In some embodiments, processor 1002 includes and/or is used to provide determination of message data to present based on a message.

Processor 1002 is coupled bi-directionally with memory 1010, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data, and objects used by the processor 1002 to perform its functions (e.g., programmed instructions). For example, memory 1010 can include any suitable computer readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000 and is coupled either bi-directionally (read/write) or uni-directionally (read only) to processor 1002. For example, storage 1012 can also include computer readable media such as magnetic tape, flash memory, PC-CARDS, portable mass storage devices, holographic storage devices, and other storage devices. A fixed mass storage 1020 can also, for example, provide additional data storage capacity. The most common example of fixed mass storage 1020 is a hard disk drive. Mass storage 1012, 1020 generally store additional programming instructions, data, and the like that typically are not in active use by the processor 1002. It will be appreciated that the information retained within mass storage 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

Embodiments disclosed herein can be realized using electronic hardware, computer software, or combinations of both. In order to explain the interchangeability of hardware and software clearly, the composition and steps of each example have been described generally according to function in the description above. Whether these functions are ultimately implemented as hardware or software depends on the specific applications and design constraints of the technical scheme. Persons skilled in the art can realize the described functions using different methods for each specified application, but such realization should not be considered to be beyond the scope of the present application.

A person skilled in the art should understand that the embodiments of the present application can be provided as methods, systems or computer program products. Therefore, the present application may take the form of complete hardware embodiments, complete software embodiments, or embodiments that combine software and hardware. In addition, the present application can take the form of computer program products implemented on one or more computer-operable storage media (including but not limited to magnetic disk storage devices, CD-ROMs, and optical storage devices) containing computer operable program codes.

The methods described in light of the embodiments disclosed herein can be implemented using hardware, processor-executed software modules, or combinations of both. Software modules can be installed in random access memory (RAM), internal memory, read-only memory (ROM), electrically programmable ROM, electrically erasable programmable ROM, registers, hard disks, removable magnetic disks, CD-ROM, or any other form of storage media widely known in the field.

The specific embodiments described above further describe in detail the purposes, technical scheme and beneficial effects of the present application. It should be understood that the aforesaid embodiments are only specific embodiments of the present application, and are not intended to limit the scope of protection of the present application. Any revisions, substitutions, or improvements that are made within the spirit and principles of the present application shall all be included within the scope of protection of the present application.

Please note that the implementation modes of the present application may be realized through hardware, software, or combinations of software and hardware. The hardware part may be realized using specialized logic. The software part may be stored in memory and executed by an appropriate command-executing system such as a microprocessor or specially designed hardware. A person with ordinary skill in the art can understand that the equipment and methods described above can be realized through computer-executable commands and/or by being contained in processor control codes. For example, such code could be provided in carrier media such as magnetic disks, CDs, or DVD-ROMs, in programmable memory such as read-only memory (firmware), or data carriers such as optical or electronic signal carriers. The equipment of the present application and the modules thereof may be realized by, for example, very large scale integrated circuits or gate arrays, by semiconductors such as logic chips or transistors, and by hardware circuits of programmable equipment such as on-site programmable gate arrays and programmable logic equipment. It can also be realized by software executed by various types of processors or by combinations of the above-described hardware circuits and software, e.g., firmware.

In addition, although the operations of the method of the present application are described according to a specific sequence in the drawings, this by no means requires or suggests that these operations must be executed according to this specific sequence or that all of the operations shown must be executed in order to achieve the expected result. On the contrary, the order of execution for the steps depicted in the flowcharts may be changed. Additionally or optionally, some steps may be omitted, or multiple steps may be merged into one step for execution, and/or one step may be broken apart into multiple steps for execution.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
identify a web address included in a message sent from a first instant messaging client to a second instant messaging client;
extract identifying information to use to identify page content from the web address;
retrieve message data corresponding to the identifying information including by sending a processing request to a server; and
present the message data within a display window of the second instant messaging client; and
one or more memories coupled to the one or more processors and configured to provide the one or more processors with instructions.

2. The system of claim 1, wherein the web address included in the message is determined by comparing a regular expression to character strings in the message.

3. The system of claim 1, wherein to identify the web address included in the message further includes to determine whether the web address is of a predetermined type.

4. The system of claim 3, wherein the web address is determined to be of the predetermined type in the event that the web address is associated with one or more specified objects.

5. The system of claim 1, wherein the identifying information from the web address is extracted using one or more preset rules.

6. The system of claim 1, wherein the processing request includes the identifying information.

7. The system of claim 1, wherein the server is configured to retrieve the message data using the identifying information and an application programming interface (API).

8. The system of claim 1, wherein the processing request specifies one or more fields to be included in the message data.

9. The system of claim 1, wherein the one or more processors are further configured to present one or more images included in the message data in an image browser, wherein the image browser is different from the display window of the second instant messaging client.

10. The system of claim 1, wherein the display window of the second instant messaging client comprises a dialog window.

11. The system of claim 1, wherein the message data is presented together with the message within the display window of the second instant messaging client.

12. A method, comprising:
identifying, using one or more processors, a web address included in a message sent from a first instant messaging client to a second instant messaging client;
extracting identifying information to use to identify page content from the web address;
retrieving message data corresponding to the identifying information including by sending a processing request to a server; and
presenting the message data within a display window of the second instant messaging client.

13. The method of claim 12, wherein the web address included in the message is determined by comparing a regular expression to character strings in the message.

14. The method of claim 12, wherein identifying the web address included in the message further includes determining whether the web address is of a predetermined type.

15. The method of claim 14, wherein the web address is determined to be of the predetermined type in the event that the web address is associated with one or more specified objects.

16. The method of claim 12, wherein the identifying information from the web address is extracted using one or more preset rules.

17. The method of claim 12, wherein the processing request includes the identifying information.

18. The method of claim 12, wherein the server is configured to retrieve the message data using the identifying information and an application programming interface (API).

19. The method of claim 12, further comprising presenting one or more images included in the message data in an image browser, wherein the image browser is different from the display window of the second instant messaging client.

20. The method of claim 12, wherein the message data is presented together with the message within the display window of the second instant messaging client.

21. A computer program product, the computer program product being embodied in a non-transitory computer readable storage medium and comprising computer instructions for:
identifying a web address included in a message sent from a first instant messaging client to a second instant messaging client;
extracting identifying information to use to identify page content from the web address;
retrieving message data corresponding to the identifying information including by sending a processing request to a server; and
presenting the message data within a display window of the second instant messaging client.
